(19) United States
(12) Patent Application Publication
(10) Pub. No.: US 2017/0064589 A1
(43) Pub. Date: Mar. 2, 2017

(54) HANDOVER APPARATUS AND METHOD

(71) Applicant: Nokia Solutions and Networks Oy, Espoo (FI)

(72) Inventors: Yang LIU, Beijing (CN); Yanji ZHANG, Beijing (CN); Tsunehiko CHIBA, Saitama (JP)

(21) Appl. No.: 15/123,412

(22) PCT Filed: Mar. 28, 2014
(86) PCT No.: PCT/CN2014/000342

§ 371 Date: Sep. 2, 2016

(51) Int. Cl. H04W 36/00; H04L 5/00

(52) U.S. Cl. CPC H04W 36/0072; H04W 36/0061; H04L 5/0055

(57) ABSTRACT

A handover apparatus is provided, comprising: means for receiving a handover request message from a first network element; means for sending a handover indication message to a second network element while sending a handover acknowledgement message to the first network element. The present disclosure manages to reduce the handover delay so as to enable fast handover for dual connectivity.

### TECHNICAL FIELD

The present disclosure relates to a handover apparatus and method.

### BACKGROUND

Dual connectivity is becoming the main stream in discussions of further LTE enhancements. In the dual connectivity, UE is simultaneously connected with a Macro eNB (MeNB) and a Secondary eNB (SeNB), and a to control plane (Radio Resource Control (RRC)) may be located in the MeNB. However, there are two solutions to be supported for a User Plane (UP): one is Option 1A with UP traffic from an SeNB to an S-GW called as a SCG bearer; and the other is Option 3C with a split bearer at the MeNB. Mobility scenarios and handover support for the dual connectivity (e.g., inter-MeNB handover cases) are also involved in the discussions.

Some issues may arise from a handover to be performed from MeNB+SeNB (dual connectivity) to another MeNB (single connectivity).

Specifically, it is necessary to perform an X2 TNL (Transport Network Layer) configuration before inter-MeNB handover. In existing mechanisms, however, a Target MeNB (T-MeNB), which communicates with a Source MeNB (S-MeNB) but not with the SeNB, may be not able to get the X2 TNL information of the SeNB, so the X2 setup could not be performed. Actually, in the case that there is a physical connection between the SeNB and the T-MeNB, the X2 interface will be ready when the SeNB connects to the network. At least in the initial phase, it can trigger the X2 interface setup procedure in a very early stage and get this X2 well prepared for future handover.

Furthermore, according to network requirements for the handover, the Source MeNB may fetch data from the source SeNB and perform the (source) SeNB release, e.g. based on a HandoverRequestAck received from the Target MeNB or based on the X2 indication that the handover is completed successfully (FFS). However, in prior art, data may not be fetched from the SeNB, but be forwarded directly to the T-MeNB.

Additionally, FIG. 1 shows an example flow diagram of a straight forward method utilizing a handover procedure similar to existing X2 handover between the source MeNB+SeNB and the target MeNB. As shown in FIG. 1, at step S101 of the method, the S-MeNB 110 may send a handover request message to the T-MeNB 130. Then, at step S102, the T-MeNB 130 may send a handover acknowledgement message to the S-MeNB 110. Next, at step S103, after receiving the acknowledgement message, the S-MeNB 110 may send a handover indication message to the SeNB 120. At step S104, the SeNB 120 may send a handover acknowledgement message back to the S-MeNB 110. At step S105, the S-MeNB 110 may send a handover command message to UE 140.

As can be seen, four steps in non-ideal backhaul may be needed for handover preparation before the handover command is issued. Assuming is that one-way delay is 10ms, the total delay will be 40 ms, i.e., 4 times backhaul delay. In other words, the delay will increase with the amount of signalling required.

### SUMMARY

Embodiments of the present disclosure aim at realizing an optimized mobility procedure in case of inter-MeNB handover by shortening the handover delay to achieve better system performance and user experience.

According one aspect of the present disclosure, there is provided a handover apparatus, comprising: means for receiving a handover request message from a first network element; and means for sending a handover indication message to a second network element at the same time of sending a handover acknowledgement message to the first network element.

According another aspect of the present disclosure, the handover request message may comprise a plurality of first identifiers for bearers and a second identifier of the second network element.

According another aspect of the present disclosure, the means for sending the handover indication message may comprise: means for extracting the second identifier from the handover request message; and means for sending the handover indication message to the second network element based on the extracted second identifier.

According another aspect of the present disclosure, the first identifiers may comprise identifiers used for user plane data transmission between the first network element and the second network element.

According another aspect of the present disclosure, the handover indication message may comprise the first identifiers received from the first network element.

According another aspect of the present disclosure, the apparatus may further comprise: means for receiving user plane data from the first network element.

According another aspect of the present disclosure, the user plane is data may be received by the first network element from the second network element through the first identifiers.

According another aspect of the present disclosure, the apparatus may be located in an eNB.

According another aspect of the present disclosure, the first identifiers may be tunnel endpoint identifiers (TEIDs) and the second identifier may be an enhanced cell global identifier (ECGI).

According another aspect of the present disclosure, there is provided a handover method, comprising: receiving a handover request message from a first network element; and sending a handover indication message to a second network element at the same time of sending a handover acknowledgement message to the first network element.

According another aspect of the present disclosure, the handover request message may comprise a plurality of first identifiers for bearers and a second identifier of the second network element.

According another aspect of the present disclosure, sending the handover indication message may comprise: extracting the second identifier from the handover request message; and sending the handover indication message to the second network element based on the extracted second identifier.

According another aspect of the present disclosure, the first identifiers may comprise identifiers used for user plane data transmission between the first network element and the second network element.

According another aspect of the present disclosure, the handover indication message may comprise the first identifiers received from the first network element.

According another aspect of the present disclosure, the method may further comprise: receiving user plane data from the first network element.

According another aspect of the present disclosure, the user plane data may be received by the first network element from the second network element through the first identifiers.

According another aspect of the present disclosure, the method may is be performed in an eNB.

According another aspect of the present disclosure, the first identifiers may be tunnel endpoint identifiers (TEIDs) and the second identifier may be an enhanced cell global identifier (ECGI).

In view of the above, the present disclosure manages to reduce the handover delay so as to enable fast handover for dual connectivity.

It should be noted that above described procedures may apply to network elements and/or to cells, where the cells can be radio cells which may be part of a network element, for example a base station or an eNB. A network element may comprise several cells.

### BRIEF DESCRIPTION OF THE DRAWINGS

In the following, the present disclosure will be described in greater detail by way of non-limiting examples with reference to the accompanying drawings, in which:

FIG. 1 shows an example flow diagram of a straight forward method utilizing a handover procedure similar to existing X2 handover;

FIG. 2 shows an example flow diagram of a handover procedure according to the present disclosure;

FIG. 3 shows a schematic block diagram of an example apparatus according to an exemplary embodiment of the present disclosure;

FIG. 4 shows a schematic block diagram of another example apparatus according to an exemplary embodiment of the present disclosure;

FIG. 5 shows a schematic flow chart of an example method according to an exemplary embodiment of the present disclosure; and

FIG. 6 shows a schematic block diagram of an example apparatus according to an exemplary embodiment of the present disclosure.

### DETAIL DESCRIPTION OF EMBODIMENTS OF THE DISCLOSURE

The present disclosure is described herein with reference to particular non-limiting examples and to the contents that are presently considered to be embodiments of the present disclosure. A person skilled in the art will appreciate that the present disclosure is by no means limited to these examples, and may be more broadly applied.

Some terms are used for denoting specific system components throughout the application document. As would be appreciated by those skilled in the art, different designations are usually used for denoting the same component, thus the application document does not intend to distinguish those components that are only different in name rather than in function. In the application document, terms “comprise”, “include” and “have” are used in an opening way, and thus they shall be construed as meaning “comprise but not limited to . . . ”. Besides, the term “coupled”, as may be used herein, includes direct coupling and indirect coupling via another component. Inferred coupling, for example where one element is coupled to another element by inference, includes direct and indirect coupling between two elements in the same manner as “coupled”.

The following detailed description refers to the accompanying drawings that show, by way of illustration, specific details and aspects of this disclosure. The word “exemplary” is used herein to mean “serving as an example, instance, or illustration”. Any aspect of this disclosure or design described herein as “exemplary” is not necessarily to be construed as preferred or advantageous over other aspects of this disclosure or designs.

Some figures may use similar reference numbers. This is merely to indicate that the same number in different figures may be similar types of items. However, the same number in different figures may be each its own iteration or aspect of this disclosure.

Although SCG (Small Cell Group) bearers are used in the descriptions below, it is not restricted to bearers only, which means that even for UP Option 3C, the technical solution according to the present disclosure may be employed to execute the optimized handover procedure, and a similar signal flow will be followed accordingly.

Further, it should be noted that although Forwarding TEIDs (Tunnel Endpoint IDentifiers) and ECGI (Enhanced Cell Global Identifier) are used herein, other kinds of identifiers, for example related to tunnels or network elements, can also be employed.

In the present disclosure, there exists a need to have an X2 interface between the T-MeNB and the SeNB. However, for an SeNB (e.g. Pico) deployed around macro eNBs, it is practical to assume that the SeNB is connected with its neighbouring macro eNBs via this X2 interface.

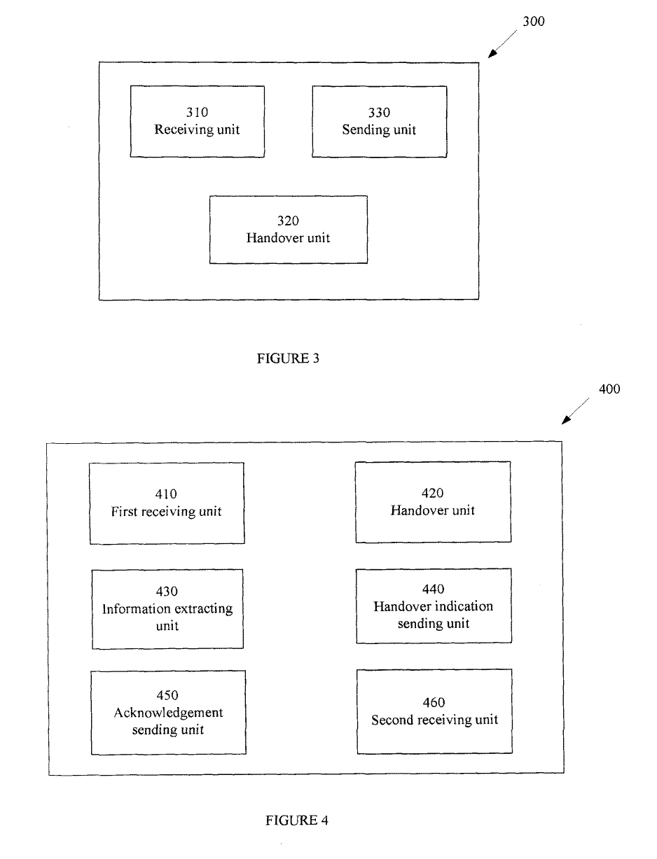

FIG. 2 shows an example flow diagram of a handover procedure according to the present disclosure. FIG. 3 shows a schematic block diagram of an example apparatus according to an exemplary embodiment of the present disclosure. The handover procedure showed in FIG. 2 will be described in detail by means of the example apparatus of FIG. 3.

The apparatus 300 shown in FIG. 3 may comprise a receiving unit 310, a handover unit 320 and a sending unit 303. The apparatus 300 may be located in an eNB, e.g., a T-MeNB 230 as shown in FIG. 2.

The receiving unit 310 may receive, from for example an S-MeNB 210 shown in FIG. 2, a handover request message, as shown at step S201. The handover request message may comprise new information elements, such as for example:
forwarding TEIDs for SCG bearers;
ECGI of an SeNB.

It should be noted that there may be two types of bearers, i.e., MCG (Macro Cell Group) bearers and SCG bearers in this handover request message. For the SCG bearers in this example embodiment, two kinds of TEID may be needed, i.e., TEIDs used for data forwarding between the S-MeNB 210 and the T-MeNB 230 as well as TEIDs of all SCG bearers for future data forwarding between the SeNB 220 and the S-MeNB 210.

The handover unit 320 of the apparatus 300 may then perform handover for UE 240, and the sending unit 303 of the apparatus 300 may send a handover indication message to the SeNB 220 via an X2 interface between the T-MeNB 230 and the SeNB 220, e.g., based on the ECGI of the SeNB 220 provided by the S-MeNB 210, as shown at step S202. The handover indication message may comprise the TEIDs received by the receiving unit 310 from the S-MeNB 210.

The sending unit 330 may send an acknowledgement message to the S-MeNB 210, e.g., as shown at step S203, at the same time as the above handover and the indication message transmission. Thus, the handover indication to the SeNB may be performed by the T-MeNB itself instead of the S-MeNB. This could finally save preparation time for the whole handover procedure.

After receiving the handover indication message from the sending unit 330, the SeNB 220 may perform the data forwarding for all of the SCG bearers to the S-MeNB 210 according to the forwarding TEIDs provided in the received handover indication message, e.g., as shown at step S204, so that the S-MeNB 210 will get all the user plane data through the above-mentioned TEIDs for the data forwarding between the SeNB 220 and the S-MeNB 210, and forward it to the T-MeNB 230.

In the case that the S-MeNB 210 performs multiple X2 handover preparation procedures in parallel to different T-MeNBs (i.e. using different X2 links), as compared to prior art in which data forwarding could be performed towards an arbitrary T-MeNB which is not selected by the S-MeNB 210, in the example embodiment of the present disclosure, by receiving the user plane data of the SCG bearers forwarded by the SeNB 220, the S-MeNB 210 may perform data forwarding towards the final selected T-MeNB.

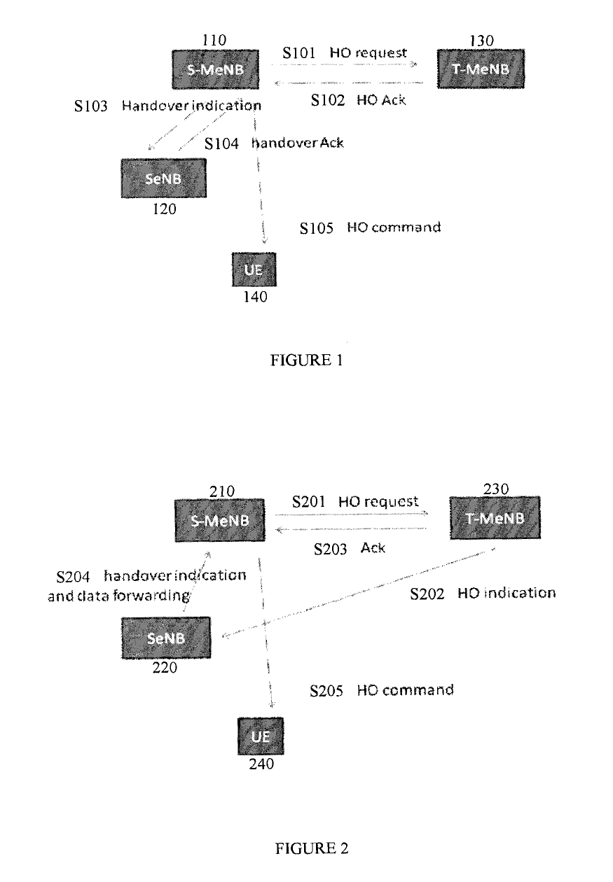

Finally, similar to step S105 in FIG. 1, the S-MeNB 210 may send a handover command to the UE 240 to initiate the handover.

As described above, due to the simultaneous operations of steps S202 and S203, the delay of the handover preparation before the handover to command is issued is only 3 times backhaul delay. Assuming again that the one-way backhaul delay is 10 ms, this can save 25% time as compared with the prior art, i.e., from 40 ms to 30 ms.

FIG. 4 shows a schematic block diagram of another example apparatus according to an exemplary embodiment of the present disclosure. The apparatus 400 shown in FIG. 4 may also be located in an eNB, e.g., a T-MeNB 230 as shown in FIG. 2. The apparatus 400 may comprise a first receiving unit 410, a handover unit 420, an information extracting unit 430, a handover indication sending unit 440, an acknowledgement sending unit 450 and a second receiving unit 460.

Specifically, the first receiving unit 410 may be configured to receive a handover request message from an S-MeNB. The handover request message may comprise at least forwarding TEIDs for SCG bearers and ECGI of an SeNB.

The handover unit 420 may be configured to perform handover for UE. The information extracting unit 430 may be configured to extract the ECGI of the SeNB from the handover request message received from the first receiving unit 410. The handover indication sending unit 440 may be configured to send a handover indication message, including the forwarding TEIDs received by the first receiving unit 410, to the SeNB via an X2 interface between the T-MeNB and the SeNB based on the ECGI of the SeNB extracted by the information extracting unit 430.

The acknowledgement sending unit 450 may be configured to send a handover acknowledgement message to the S-MeNB while the handover indication sending unit 440 is sending the handover indication message.

The second receiving unit 460 may be configured to receive user plane data from the S-MeNB, which may obtain the user plane data from the SeNB through the TEIDs of SCG bearers for data forwarding between the SeNB and the S-MeNB.

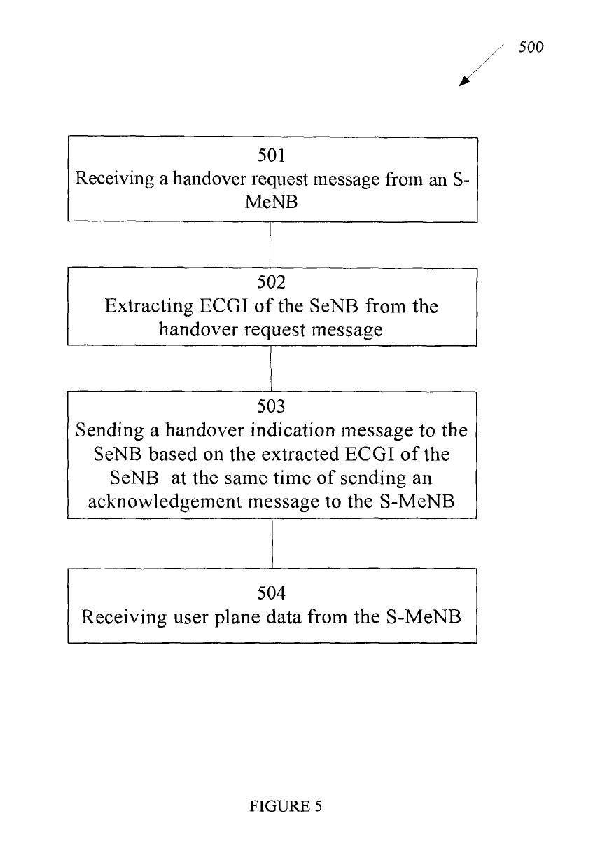

FIG. 5 shows a schematic flow chart of an example method according to an exemplary embodiment of the present disclosure. The method 500 may be performed in an eNB, such as the T-MeNB 230 as shown in FIG. 2.

As shown in FIG. 5, at block 501, a handover request message may be received from an S-MeNB. The handover request message may comprise at least Forwarding TEIDs for SCG bearers and ECGI of an SeNB.

At block 502, the ECGI of the SeNB may be extracted from the handover request message.

At block 503, a handover indication message may be sent to the SeNB, e.g. based on the extracted ECGI of the SeNB, at the same time when an acknowledgement message may be sent to the S-MeNB.

At block 504, user plane data may be received from the S-MeNB.

In this way, as described above, due to simultaneous transmission of the handover indication message and the acknowledgement message, the delay of the handover preparation before the handover command is issued becomes only 3 times backhaul delay, which can save 25% time as compared with the prior art method.

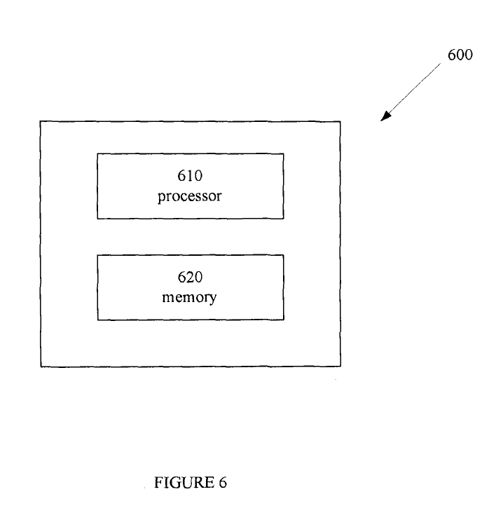

FIG. 6 shows a schematic block diagram of an example apparatus according to an exemplary embodiment of the present disclosure. The illustration of the apparatus according to FIG. 6 is simplified.

The apparatus 600 shown in FIG. 6 may comprise at least one processor 610 and at least one memory 620 storing at least one computer program code. In one embodiment, in response to being executed on the processor, the at least one computer program code may cause the processor to carry out the method steps as mentioned above in blocks 501-504.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

The above examples can be implemented by hardware, software or firmware or a combination thereof. For example, the various methods, processes and functional modules described herein may be implemented by a processor (the term processor is to be interpreted broadly to include a CPU, processing unit, ASIC, logic unit, or programmable gate array etc.). The processes, methods and functional modules may all be performed by a single processor or split between several processers; reference in this disclosure or the claims to a “processor” should thus be interpreted to mean “one or more processors”. The processes, methods and functional modules may be implemented as machine readable instructions executable by one or more processors, hardware logic circuitry of the one or more processors or a combination thereof. Further the teachings herein may be implemented in form of a software product. The computer software product is stored in a storage medium and comprises a plurality of instructions for making a computer device (which can be a personal computer, a server or a network device such as a router, switch, access point etc.) implement the method recited in the examples of the present disclosure.

Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) s medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

Even though the present disclosure is described above with reference to the examples according to the accompanying drawings, it is to be understood that the present disclosure is not restricted thereto. Rather, it is apparent to those skilled in the art that the present disclosure can be modified in many ways without departing from the scope of the inventive idea as disclosed herein.

1-18. (canceled)

19. A handover apparatus, comprising:
at least one processor; and
at least one memory including computer program code,
the at least one memory and the computer program code configured, with the at least one processor, to cause the apparatus at least to
receive a handover request message from a first network element; and
send a handover indication message to a second network element at substantially the same time of sending a handover acknowledgement message to the first network element.

20. The apparatus according to claim 19, wherein the handover request message comprises a plurality of first identifiers for bearers and a second identifier of the second network element.

21. The apparatus according to claim 20, wherein sending the handover indication message comprises:
extracting the second identifier from the handover request message; and
sending the handover indication message to the second network element based on the extracted second identifier.

22. The apparatus according to claim 20, wherein the first identifiers comprise identifiers used for user plane data transmission between the first network element and the second network element.

23. The apparatus according to claim 20, wherein the first identifiers are tunnel endpoint identifiers (TEIDs) and wherein the second identifier is an enhanced cell global identifier (ECGI).

24. The apparatus according to claim 19, wherein the handover indication message comprises the first identifiers received from the first network element.

25. The apparatus according to claim 19, wherein the at least one processor; and the at least one memory including computer program code, the at least one memory and the computer program code further configured, with the at least one processor, to cause the apparatus at least to
receive user plane data from the first network element.

26. The apparatus according to claim 25, wherein the user plane data is received by the first network element from the second network element through the first identifiers.

27. The apparatus according to claim 19, wherein the apparatus is located in an eNB.

28. A handover method, comprising:
receiving a handover request message from a first network element; and
sending a handover indication message to a second network element at substantially the same time of sending a handover acknowledgement message to the first network element.

29. The method according to claim 28, wherein the handover request message comprises a plurality of first identifiers for bearers and a second identifier of the second network element.

30. The method according to claim 29, wherein sending the handover indication message comprises:
extracting the second identifier from the handover request message; and
sending the handover indication message to the second network element based on the extracted second identifier.

31. The method according to claim 29, wherein the first identifiers comprise identifiers used for user plane data transmission between the first network element and the second network element.

32. The method according to claim 29, wherein the handover indication message comprises the first identifiers received from the first network element.

33. The method according to claim 29, wherein the first identifiers are tunnel endpoint identifiers (TEIDs) and wherein the second identifier is an enhanced cell global identifier (ECGI).

34. The method according to claim 28, further comprising:
receiving user plane data from the first network element.

35. The method according to claim 34, wherein the user plane data is received by the first network element from the second network element through the first identifiers.

36. The method according to claim 28, wherein the method is performed in an eNB.

37. A computer program product, embodied on a non-transitory computer readable medium, wherein the computer program is configured to control an apparatus to perform a process comprising:
receive a handover request message from a first network element; and
send a handover indication message to a second network element at substantially the same time of sending a handover acknowledgement message to the first network element.

38. The computer program product according to claim 37, wherein the handover request message comprises a plurality of first identifiers for bearers and a second identifier of the second network element and wherein sending the handover indication message comprises:
extracting the second identifier from the handover request message; and
sending the handover indication message to the second network element based on the extracted second identifier.
